(19) United States
(12) Patent Application Publication
(10) Pub. No.: US 2025/0026656 A1
(43) Pub. Date: Jan. 23, 2025

(54) CONTINUOUS CLEANING SYSTEM FOR HALOGEN SALTS

(71) Applicant: Deutsches Zentrum Für Luft- Und Raumfahrt E.V, Bonn (DE)

(72) Inventors: Wenjin DING, Köln (DE); Qing GONG, Köln (DE); Thomas BAUER, Köln (DE)

(21) Appl. No.: 18/713,741

(22) PCT Filed: Nov. 29, 2022
(86) PCT No.: PCT/EP2022/083584

§ 371 Date: May 28, 2024

(30) Foreign Application Priority Data
Nov. 29, 2021 (DE) 10 2021 131 250.7

(51) Int. Cl. C01D 3/20; C01D 3/04; C01F 5/30

(52) U.S. Cl. CPC C01D 3/20; C01D 3/04; C01F 5/30

(57) ABSTRACT

Processes and devices for reducing impurities in halogen salts, where the halogen salt is brought into contact with an active metal. The halogen salts purified in this way are suitable for use as high-temperature storage materials in thermal power plants and for industrial process heat, or as electrolytes in batteries.

### CROSS-REFERENCE TO RELATED APPLICATION

The present disclosure is a national stage and claims the benefit of priority of co-pending PCT/EP2022/083584, entitled “CONTINUOUS CLEANING SYSTEM FOR HALOGEN SALTS,” the contents of which are incorporated in full by reference.

### TECHNICAL FIELD

The present disclosure generally relates to processes and devices for reducing impurities in halogen salts, where the halogen salt is brought into contact with an active metal. The halogen salts purified in this way are suitable for use as high-temperature storage materials in thermal power plants or batteries, and for industrial process heat.

### BACKGROUND

Molten salts have been employed commercially for some years in solar-thermal power plants, and enable thermal energy for power plants to be transferred and stored on a large scale and in an environment-friendly way. Currently, a mixture of two nitrate salts has often been used as a heat-transfer medium and storage medium in solar-thermal power plants. (so-called solar salt, a mixture of 40% by weight potassium nitrate and 60% by weight sodium nitrate). This mixture has a particular operating range with respect to the minimum temperature (because of the melting temperature) and the maximum temperature (because of thermal decomposition). The maximum working temperature of solar salt is limited to about 560° C. because of thermal decomposition. Molten salts having higher maximum working temperatures can significantly improve the efficiency of downstream processes in solar power plants (e.g., in steam cycles for power generation), and offer options for high temperature heat transfer fluids in other industrial applications.

In addition, the production of nitrate salts by the Haber-Bosch process requires large amounts of energy. Thus, the cost of solar salt is rather high. The storage application requires large amounts of nitrate salt. Thus, for example, the Andasol power plant in Spain with 50 MWₑₗ and a storage period of 7 hours needs about 28,000 metric tons of solar salt. The annual quantity on the world market or the production capacities of sodium nitrate are comparatively low for such a storage application. Nitrates are mainly employed as fertilizers, so that there may be price influences between the fertilizer and energy storage markets. Thus, all in all, there are disadvantages in terms of the availability of nitrate salts.

Further, it is necessary to provide high temperature heat storage materials that can be employed at higher temperatures as compared to solar salt. At the same time, the corrosivity of the heat storage material has to be low in order that the service life of a plant is not reduced.

Halogen salts are basically suitable as high temperature heat storage materials. They have a high thermal stability of >800° C. However, because of impurities in the melt, such as hydroxides, they are highly corrosive. Anhydrous halogen salts are mostly hygroscopic. Upon contact with air, the atmospheric humidity is sufficient for hydration. The corrosive impurities are then formed while the halogen salts are heated.

As raw salts, halogen salts have a content of corrosive impurities of typically >1% by weight. However, for halogen salts to be suitable for high temperature heat storage, it is necessary to lower this proportion to 0.05% by weight or less, especially 0.01% by weight or less.

Methods for reducing impurities in molten halogen salts have been described in the prior art. Thus, WO 2017/093030 A1 discloses a method for producing halogen salts, which are substantially free of water and oxygen, of an alkali metal, or an alkaline earth metal, or a transition metal, or a metal of group 13 or 14 of the periodic table, where the halogen salt is heated at a heating rate of 0.2 K/min to 30 K/min, starting from the ambient temperature. In particular, the heating occurs in the presence of an additive, such as ammonium chloride or magnesium. Such a method enables halogen salts having a proportion of impurities of <1% by weight to be provided.

In solar thermal power plants, operation can be effected with halogen salts having an impurity content of <0.05% by weight, preferably 0.01% by weight or less. Only then is the corrosivity sufficiently low to ensure a safe operation. In order to ensure this low proportion of impurities also during the operation of the plant, EP 3578691 A1 and WO 2020/193305 A1 describe methods in which a continuous purification is effected by means of an electrochemical process.

However, there is still a need for a method that closes the gap between these methods known in the prior art, i.e., enables impurities in halogen salts to be reduced from about 1% by weight to ≤0.05% by weight, preferably ≤0.01% by weight.

### SUMMARY

It has been found that this is possible by contacting the halogen salt with an active metal in liquid form. Therefore, in a first embodiment, the object of the present disclosure is achieved by a process for reducing impurities in a halogen salt or halogen salt mixtures of two, three or more halogen salts, including the following steps:
a) providing a container in which the halogen salt or halogen salt mixture is brought into contact with an active metal,
b) providing said halogen salt or halogen salt mixture, which is in a liquid form,
c) providing an active metal,
d) contacting said halogen salt or halogen salt mixture with said active metal in an inert atmosphere at a temperature that is above the melting temperature of said active metal, whereby impurities in said halogen salt or halogen salt mixture react with said active metal to obtain a halogen salt or halogen salt mixture having a proportion of impurities of 0.05% by weight or less, especially of 0.01% by weight or less, and
e) separating the purified halogen salt or halogen salt mixture,
where
said halogen salt is a halogen salt of an alkali metal, or an alkaline earth metal, or a transition metal, or a metal of group 13 or 14 of the periodic table, said inert atmosphere consists of nitrogen and/or noble gas, and said active metal is selected to
   be immiscible with the molten halogen salts,
   have an electromotive force (EMF) that is not larger than that of the metals forming the cations of the halogen salt or salts,
   have an electromotive force (EMF) that is larger than that of the corrosive impurities of the halogen salt or salts, and
   have a density different from that of the purified halogen salt.

According to the disclosure, the active metal is not miscible with the melt of one, two, three or more halogen salts, i.e., the molten halogen salts. According to the disclosure, this means that the liquid phase of the active metal and the liquid phase of the halogen salt exist together as separate phases. Further, not even in its liquid form does the active metal undergo a reaction with the purified halogen salt. This means that the electromotive force (EMF) of the active metal is lower than or equal to, but not larger at any rate, than that of all the metals in the molten halogen salts that are derived from the halogen salt. In addition, the electromotive force of the active metal is larger than that of the corrosive impurity of the halogen salt. This results in the desired reaction and thus in the purification of the halogen salt or halogen salt mixture.

In the contacting in step d) of the process according to the disclosure, the active metal reacts with the corrosive impurities of the halogen salt. A reaction product is formed from the impurity and the active metal. Usually, a metal oxide is formed. The metal oxide has a higher density and will therefore sink to the ground of the container, so that it is separated from the active metal and the halogen salt.

Thus, according to the disclosure, it is possible to purify liquid halogen salts by contacting them with a liquid active metal. In particular, it becomes possible to remove corrosive impurities from the halogen salt. Such impurities include, in particular, those impurities and thus compounds that contain oxygen and/or hydrogen in addition to the cation and anion of the halogen salt. One particularly abundant impurity is one in which the halogen salt has a hydroxy group. For example, if the halogen salt is magnesium chloride, it may contain MgOHCl as a highly oxidative corrosive impurity, to name just one example.

The contacting of the halogen salt with the active metal is performed at a temperature that is above the melting temperature of the active metal and above the melting temperature of the halogen salt. According to the disclosure, the halogen salt and the active metal are liquids during the process according to the disclosure. According to the disclosure, it is irrelevant whether the active metal and the halogen salt are both mixed together at first as solids, followed by heating until the active metal is molten, or whether the active metal is charged and molten at first, followed by adding the halogen salt. It is also conceivable to charge the halogen salt first and subsequently to supply to the halogen salt the liquid active metal that had been heated and molten in a separate container.

It is particularly preferred if the container according to the disclosure has a heating device. The heating device can heat the container at the working temperature above the melting temperature of the active metal and above the melting temperature of the halogen salt and maintain it at the working temperature of the container. The working temperature of the container is to be above the melting temperature of the active metal and above the melting temperature of the halogen salt, and below the decomposition temperature of the halogen salt.

According to the disclosure, it is irrelevant whether the active metal or the halogen salt/halogen salt mixture is introduced first into the container and heated. If the active metal or the halogen salt/halogen salt mixture is liquid, the other component respectively is added. If the metal is charged and molten at first, the addition of the halogen salt follows, and if the halogen salt/halogen salt mixture is charged and molten, the addition of the active metal follows. According to the disclosure, it is also possible that both the active metal and the halogen salt/halogen salt mixture are added to the container, and the heating is performed thereafter.

Especially at the beginning of the process, the order of adding is relevant. According to the disclosure, it is preferred that the purification process proceeds continuously, so that the halogen salt/halogen salt mixture is continuously added to the container for purification during the operation, and any consumed active metal is supplemented if needed.

The contacting of the halogen salt with the active metal enables that the corrosive impurities in the halogen salt/halogen salt mixture react with the active metal to form non-corrosive species, e.g., a metal oxide of the active metal and a halogen salt. When metal oxides form, they usually have a low solubility and precipitate in the liquid (liquid active metal); the metal oxide can thereby be separated from the molten salt and the active metal. The halogen salt itself is purified, so that there are no further corrosive impurities. After a sufficient reaction time, i.e., a sufficient contact time between the halogen salt and the active metal, it is possible according to the disclosure to reduce the proportion of impurities in the halogen salt to 0.05% by weight or less, especially 0.01% by weight or less.

Subsequently, the purified halogen salt is separated from the active metal and from the precipitated metal oxide that may have been formed. This takes place, in particular, because the components have different densities. The metal oxide has the highest density and is found on the bottom of the container. If the halogen salt/halogen salt mixture has a density higher than that of the liquid active metal, it is above the metal oxide in the direction of space, and the active metal is still further above in the direction of space. Thus, the components become arranged in three zones in the container because of their different densities: active metal above; purified melt as the largest volume in the middle; metal oxide on the bottom below.

Alternatively, it is also possible that the halogen salt floats on the active metal and is removed from the surface, if it has a density lower than that of the active metal. This embodiment also results in a structure of three zones in the container: metal oxide on the bottom, the active metal above that, and the halogen salt floats above and forms the uppermost layer.

According to the disclosure, the halogen salt and the active metal have different densities. This enables the components to be separated. In particular, the purified halogen salt has a density that is higher than that of the molten active metal. This enables that the halogen salt, when added on the surface of the molten material, slowly sinks through the liquid active metal to the bottom of the container. This sinking process of the halogen salt prolongs the reaction time and also increases the contact area of the halogen salt with the liquid active metal. The overall reaction time depends on the contact time, and the reaction rate depends on the contact area, which can both be controlled by designing the container, and through the amount of the active metal. When the “halogen salt” is described in the present application, this is meant to include a respective mixture of two, three or more halogen salts.

When the active metal is selected, it is critical that the active metal is not miscible with the halogen salt and also does not undergo a reaction with the components of the purified halogen salt. However, a reaction has to take place with the contaminated halogen salt, or with the impurities contained in the halogen salt, i.e., in particular, with oxygen and/or hydrogen and/or hydroxides.

The active metal must have certain properties. Thus, for example, it must react only with corrosive impurities of the halogen salt, but not with the halogen salt as such. More preferably, the active metal is selected from magnesium, sodium, potassium, calcium, zinc and/or aluminum, especially from magnesium, sodium, potassium, calcium, zinc or aluminum. Thus, mixtures of 2, 3 or more of these metals are included. According to the disclosure, alloys of 2, 3 or more of these metals are also included. These effectively remove impurities from halogen salts. However, depending on the kind of halogen salt, sodium, potassium and calcium may exchange cations in the halogen salt, and cause the halogen salt itself to be changed. Therefore, the active metal is more preferably magnesium for Mg-containing halogen salts or mixtures, especially for MgCl₂-containing halogen salts or mixtures.

The contacting between the active metal and halogen salt is effected at a temperature above the melting temperatures of the active metal and of the halogen salt/halogen salt mixture.

Especially if the active metal is magnesium and the halogen salt is a mixture containing NaCl, MgCl₂ and KCl, the contacting is carried out at a temperature of from 650° C. to 750° C., especially at 700° C. Preferably, the contacting is carried out at a temperature of from 660° C. or more, especially at 680° C. or more, preferably at about 700° C. At this temperature, an effective reaction with the impurities takes place.

The contacting of the halogen salt with the active metal takes place in an inert atmosphere. It can be achieved by nitrogen or noble gases, where argon, nitrogen, helium, neon or mixtures of two or three thereof are particularly suitable. More preferably, the inert atmosphere is formed by one or more noble gases selected from argon, helium and/or neon. More preferably, the reaction takes place in an argon atmosphere, because this noble gas is less expensive and more simply available as compared to the other noble gases.

More preferably, according to the disclosure, the halogen salt is a chloride salt and/or a fluoride salt, even more preferably a chloride salt. The cation of the halogen salt is an alkali metal, an alkaline earth metal, or a transition metal, or a metal of group 13 or 14 of the periodic table. More preferably, the cation is selected from magnesium, calcium, sodium, potassium, lithium, strontium, barium, zinc, aluminum, tin, iron, chromium, manganese, or nickel. More preferably, the cation of the halogen salt is selected from magnesium, calcium, sodium, potassium, zinc, lithium, strontium, and barium.

According to the disclosure, the halogen salt may also be a mixture of 2, 3 or more different halogen salts. More preferably, the halogen salt is a mixture of magnesium chloride, potassium chloride, sodium chloride, calcium chloride and zinc chloride, or magnesium chloride, potassium chloride, sodium chloride, calcium chloride and zinc chloride, or of magnesium chloride, potassium chloride, and calcium chloride. Other mixtures are also included according to the disclosure. It may again be pointed out that all details relating to one halogen salt also relate to mixtures of 2, 3 or more halogen salts.

In order to effectively remove the impurities from the halogen salt, said contacting has to last for a sufficient period of time. This period of time is determined by the difference in density between the liquid halogen salt and the liquid active metal. However, this period can be influenced according to the disclosure. One possibility thereof is, for example, the agitation of the liquid, i.e., the mixture of liquid active metal and the liquid halogen salt within the container. The agitation can be effected, for example, by moving the container as such. An agitation can also be effected by injecting inert gas through a nozzle. The bubbles formed in the liquid active metal/halogen salt cause the components to be mixed together. The surface area becomes larger, and the separation because of the differences in density becomes slower. Mixing may also be effected by stirring. The stirring also causes the salt to be mixed with the liquid active metal. If the density of the active metal is lower than that of the halogen salt, then the stirring has the effect that the salt sinks to the ground of the container more slowly. If the halogen salt has a density lower than that of the liquid active metal, then the stirrer ensures that the salt is mixed with the liquid active metal and floats towards the surface rather slowly. Thus, according to the disclosure, agitation includes any kind of agitation that directly or indirectly moves the liquid metal and the liquid molten halogen salt, such as stirring, injecting gas, pumping, convection currents, etc. However, according to the disclosure, it is not provided or necessary that a current or voltage is applied during the process. Therefore, in a preferred embodiment, it is provided that no current or voltage is applied during the whole process and, in particular, in step d) of the process. This refers to the application of a current/voltage that would influence the between the active metal and the halogen salt in some way.

The duration of contacting and the reaction rate (i.e., cleaning rate) can be additionally influenced by the stirring speed. When an inert gas is injected, the duration of contacting can be additionally influenced by the amount of gas and the arrangement of the nozzles. In this case, the inert gas is preferably the same as the one that forms the inert atmosphere in the interior of the container. In addition, both the stirring and the injection of inert gas have the effect that the contact area increases, and corrosive impurities of the halogen salt react more quickly with the active metal, whereby the cleaning rate is improved.

According to the disclosure, it is possible to operate the present process in a discontinuous mode. In this case, the container is charged with a halogen salt and an active metal. When the reaction is complete, the purified halogen salt and optionally the molten active metal are removed. The container may be recharged with new unpurified halogen salt, which will then react with any molten active metal remaining in the container.

However, it is also possible to operate the process according to the disclosure in a continuous mode. In this case, the purified halogen salt is continuously removed from the container, and the contaminated salt is continuously supplied.

### BRIEF DESCRIPTION OF THE DRAWINGS

FIG. 1 schematically shows a device for performing a process according to the disclosure as a continuous process.

FIG. 2 shows a corresponding EDX analysis.

FIG. 3 shows a corresponding scanning electron micrograph.

### DETAILED DESCRIPTION

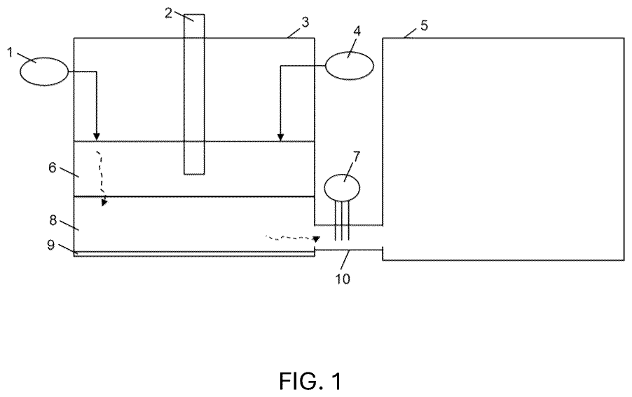

FIG. 1 schematically shows a device for performing a process according to the disclosure as a continuous process. The halogen salt/halogen salt mixture (1) is added to the container (3), in which the molten active metal (6) is provided. A stirrer (2) is provided in the interior of the container. Active metal can be supplied via the supply line (4). The metal oxide (9) forming during the cleaning collects on the bottom of the container (3).

The purification of the halogen salt can be monitored by CVM (7). If the concentration of impurity is sufficiently low, the purified halogen salt (5) can be pumped into a tank (5) through suitable pipelines (10). The pipelines (10) preferably have filters for separating metal oxide (9) from the purified halogen salt (5).

According to the disclosure, it is possible that the proportion of impurities in the halogen salt is continuously monitored by cyclic voltammetric measurements (CVM), or the corrosivity of the molten salt is continuously monitored by other measurements (e.g., measurements of redox potential with electrochemical methods, such as open circuit potential (OCP) measurements). Only when the proportion of impurities or the corrosivity of the molten salt is sufficiently low, a separation of the halogen salt from the active metal is performed.

After the end of the purification process, the purified salt can be transferred to a suitable storage tank, and then be available for thermal storage. This pumping process can also be monitored by cyclic voltammetric or OCP measurements in order to ensure the quality of the purified halogen salt. The concentration of hydrogen in the inert gas may also be monitored by a hydrogen sensor, in order to maintain the safety of the container and the high cleaning rate.

The reaction of the liquid active metal with the impurities of the halogen salt forms impurities in the active metal or gas, such as metal oxides and hydrogen. These metal oxides usually have a density higher than that of the liquid active metal, so that such impurities collect on the bottom of the container. These impurities can be removed from the container continuously or at defined time intervals, e.g., the metal oxides can be filtered off with a ceramic filter; hydrogen can be removed from the inert gas by using a hydrogen separation membrane.

The purification by means of the process according to the disclosure reduces the concentration of impurities in the halogen salt to 0.05% by weight or less, especially to 0.01% by weight or less. Especially in those cases where the proportion of impurities does not exceed 3% by weight or less at the beginning of the process, it is possible to select the material of the container in such a way that at the interior side, where it comes into contact with halogen salt and liquid metals, it is made of stainless steel and/or a ceramic material and/or a carbon material and/or alumina-forming steels. If magnesium is used as an active metal, the steel should not contain nickel, because nickel can be dissolved in liquid Mg. Known steels, such as 1.0XXX, 1.1XXX, 1.47XX or 1.49XX, may be used. Therefore, more preferably, the halogen salt/the halogen salt mixture has a proportion of corrosive impurities of 3% by weight or less, preferably 2% or less, especially 1% or less, at the beginning of the process.

Especially in a discontinuous process, excess active metal can be stored separately, used again at a later time, or remain in the container for the next salt cleaning. Thus, the amount of active metal needed is high only at the beginning of the reaction. Since only small amount are consumed by the reaction with impurities, the consumption of active metal is low. Only small amounts have to be fed, in order to provide a sufficient amount, so that an effective reaction with the halogen salt can be enabled.

The metal oxide that usually forms in the reaction with the impurity in the halogen salt has a density higher than that of the purified halogen salt and of the molten metal, so that a corresponding separation is possible because of the sedimentation alone.

In order to avoid the mixing of the purified halogen salt with the metal oxide or other metallic impurities, a suitable filter may be provided that separates magnesium oxide from the halogen salt. The removal of the purified halogen salt from the container should be performed with little agitation only, in order to keep the purified halogen salt free from other materials.

The inert atmosphere is contaminated by hydrogen that forms. However, the amount of contamination is low, since the proportion of impurities in the halogen salt is preferably low. Preferably, however, the proportion of hydrogen is to be monitored. More preferably, a continuous purification of the inert gas is performed, in which the inert gas is removed from the container, purified from hydrogen, and then returned.

The hydrogen obtained can be separated and stored for some other processes.

If a mixture of magnesium chloride (MgCl₂), potassium chloride (KCl) and sodium chloride (NaCl) is used as the halogen salt, the use of liquid magnesium as the active metal is particularly suitable, because it is the metal with the lowest EMF that does not react with MgCl₂, KCl and NaCl.

The main corrosive impurities in a corresponding MgCl₂—KCl—NaCl salt mixture are MgOHCl and HCl. Especially MgOHCl is present as an impurity, because it has a high solubility in the molten halogen salt. MgOHCl, like HCl, is formed during the hydrolysis of MgCl₂. The reaction is schematically shown below:

MgCl₂×H₂O→MgOHCl+HCl_{(g)}(at >240° C.)

When MgOHCl reacts with a metal, for example, in a steel tank, MgO and the corresponding metal chloride are obtained. Hydrogen escapes. Thus, the steel tank dissolves.

Now, when MgOHCl is brought into contact with magnesium, the following reaction takes place:

Mg_{(s/l)}+2MgOHCl₍ₗ₎→2MgO₍ₛ₎+MgCl₂₍ₗ₎+H_{2(g)}.

In this chemical equation, magnesium oxide is continuously removed, since it sinks to the ground because of its higher melting point and higher density. Also, hydrogen can escape as a gas. The equilibrium of the reaction is thereby shifted to the right side. Thus, purified MgCl₂ is obtained, which is available as a high temperature heat storage material.

Hydrogen can escape from the melt. It is then contained in the inert atmosphere above the melt of the active metal. Therefore, the pressure in the container is preferably controlled. Further, in a preferred embodiment, the noble gas can be replaced at a regular basis, or continuously flushed, in order to avoid too large amounts of hydrogen in the atmosphere. The noble gas can be purified and reused.

In the chemical equations, the respective states of matter are stated as indices. The meanings are: s: solid, l: liquid, and g: gaseous. The states of matter respectively relate to the temperature prevailing during the reaction.

The corrosivity of a salt purified by a process according to the disclosure that contains MgCl₂, KCl and NaCl was tested in the following Example.

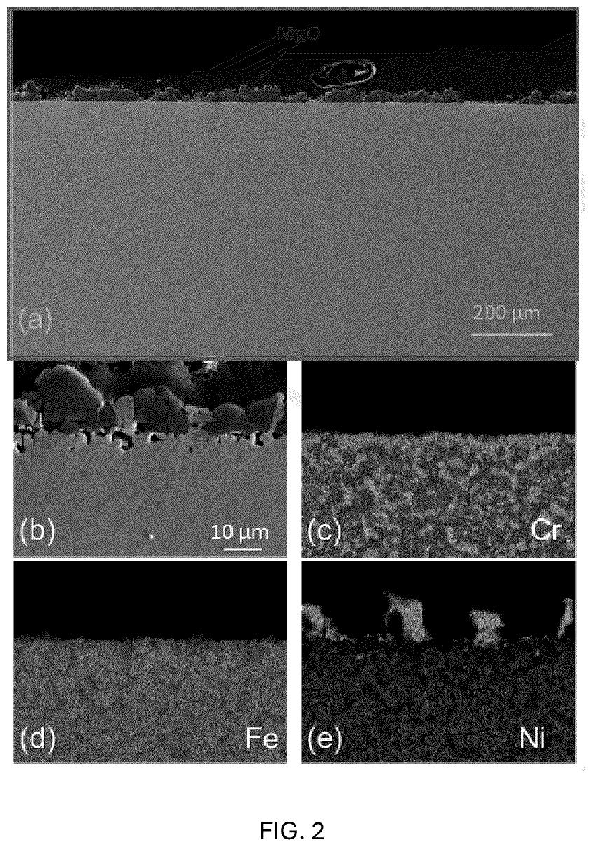

At first, five portions of 50 g of MgCl₂—KCl—NaCl were weighed in a glove box. Each of these samples was added to a respective container made of aluminum oxide together with 2.8% by weight of magnesium (based on the amount of halogen salt). In a furnace, the samples were heated at 700° C. in an argon atmosphere. After 16 hours, samples of stainless steel (SS 310,1.4845) were immersed into the halogen salts thus obtained. After 100, 250, 500, 1000 and 2000 hours, the steel samples were removed from the molten salt, rinsed with water, and analyzed. FIG. 2 shows a scanning electron micrograph of the sample, which had been immersed in a molten halogen salt for 2000 hours. From EDX analyses, it can be seen that magnesium oxide is deposited at the surface.

The EDX analysis additionally showed that no chromium has leaked, and that no corrosion took place in any other way. The corresponding EDX analysis is also included in FIG. 2.

The analysis of the scanning electron micrographs yields a corrosion rate of less than 15 μm per year. This corresponds to less than 1 mm corrosion in about 30 years.

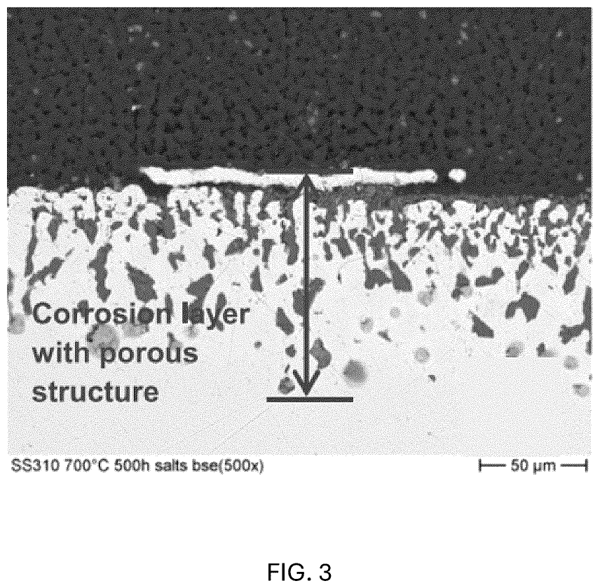

The same analyses were performed with a mixture of halogen salts without a purification by the process according to the disclosure. This yielded a corrosion rate of 1752 μm per year. A corresponding scanning electron micrograph is shown in FIG. 3.

Thus, the process according to the disclosure enables the use of halogen salts as a thermal storage system for energy production or storage. Halogen salts also find application in corresponding batteries and as a heat transfer fluid. For such an application too, the process according to the disclosure offers the possibility to provide a sufficient purification.

1. A process for reducing impurities in a halogen salt or halogen salt mixtures of two, three or more halogen salts, comprising the following steps:
a) providing a container in which the halogen salt or halogen salt mixture is brought into contact with an active metal,
b) providing said halogen salt or halogen salt mixture, which is in a liquid form,
c) providing an active metal,
d) contacting said halogen salt or halogen salt mixture with said active metal in an inert atmosphere at a temperature that is above the melting temperature of said active metal and above the melting temperature of said halogen salt/halogen salt mixture, whereby impurities in said halogen salt or halogen salt mixture react with said active metal, to obtain a halogen salt or halogen salt mixture having a proportion of impurities of 0.05% by weight or less, especially of 0.01% by weight or less, and
e) separating the purified halogen salt or halogen salt mixture,
wherein
said halogen salt is a halogen salt of an alkali metal, or an alkaline earth metal, or a transition metal, or a metal of group 13 or 14 of the periodic table,
said inert atmosphere consists of nitrogen and/or noble gas, and
said active metal is selected to
be immiscible with the molten halogen salts,
have an electromotive force (EMF) that is not larger than that of the metals forming the cations of the halogen salt or salts,
have an electromotive force (EMF) that is larger than that of the corrosive impurities of the halogen salt or salts, and
have a density different from that of the purified halogen salt.

2. The process according to claim 1, wherein no current is applied.

3. The process according to claim 1, wherein the active metal is selected from magnesium, sodium, potassium, calcium, zinc and/or aluminum, especially from magnesium, sodium, potassium, calcium, zinc or aluminum, or from mixtures or alloys of 2, 3 or more of these metals.

4. The process according to claim 1, wherein said halogen salt is a chloride salt and/or fluoride salt, especially a chloride salt or a fluoride salt.

5. The process according to claim 1, wherein the cation of said halogen salt is selected from Mg, Ca, Na, K, Li, Sr, Ba, Zn, Al, Sn, Fe, Cr, Mn or Ni.

6. The process according to claim 1, wherein said halogen salt is a mixture of two, three or more different halogen salts.

7. The process according to claim 1, wherein said contacting is performed with agitation.

8. The process according to claim 1, wherein said halogen salt has a density higher than that of the liquid active metal.

9. The process according to claim 1, wherein the impurity in the halogen salt is a compound that contains oxygen and/or hydrogen in addition to the cation and anion of the halogen salt.

10. The process according to claim 1, wherein said process is a continuous process.

11. The process according to claim 1, wherein said process is a discontinuous process.

12. The process according to claim 1, wherein the material of the container with which the halogen salt and active metal come into contact is selected from stainless steel, which in particular is free from nickel and/or a ceramic material, and/or a carbon material, and/or alumina-forming steels.

13. The process according to claim 1, wherein the halogen salt has a proportion of impurities of 3% by weight or less, especially 2% or less, preferably 1% or less, before the process according to the disclosure is performed.

14. The process according to claim 1, wherein the concentration of impurities is monitored by means of cyclic voltammetric measurements, or the corrosivity of the salt is monitored by means of OCP measurements.

15. The process according to claim 1, wherein the active metal is magnesium and the halogen salt is a mixture containing NaCl, MgCl₂ and KCl.

16. The process according to claim 15, wherein the contacting is carried out at a temperature of from 650° C. to 750° C., especially at 700° C.
